(19) United States
(12) Patent Application Publication
(10) Pub. No.: US 2014/0053666 A1
(43) Pub. Date: Feb. 27, 2014

(54) Wireless Communication Platform for Operation in Conduits

(71) Applicants: Peter S. Aronstam, Houston, TX (US); Roger Fincher, Conroe, TX (US)

(72) Inventors: Peter S. Aronstam, Houston, TX (US); Roger Fincher, Conroe, TX (US)

(21) Appl. No.: 13/970,956

(22) Filed: Aug. 20, 2013

Related U.S. Application Data
(60) Provisional application No. 61/691,280, filed on Aug. 21, 2012.

(51) Int. Cl. G01V 11/00

(52) U.S. Cl. CPC G01V 11/002
USPC 73/865.8

(57) ABSTRACT

Described herein are systems, devices, and methods for sensing, measuring, transmitting, and receiving information pertaining to a live oil or gas production environment. A measuring device may be positioned and secured within a production conduit in such a manner that sudden changes in temperature resulting in expansion of one or more components of the measuring device do not disrupt or negatively impact electrical connections established between the measuring device and the inner wall of the conduit. As a result, the measuring device described herein may reside in the conduit for longer periods of time while maintaining optimum performance. Further, the measuring device may be retrofit within an existing production environment and selectively secured at a desirable location within the production conduit.

This application claims the benefit of U.S. Provisional Application No. 61/691,280, filed Aug. 21, 2012, which is incorporated herein by reference.

### FIELD OF THE DISCLOSURE

The present disclosure is related to oil and gas production environments. In particular, the present disclosure is related to communication systems and methods within a production environment.

### BACKGROUND OF THE DISCLOSURE

In oil and gas production, conduits are commonly used to transport or direct fluid and gas. Examples of such conduits are well casings buried within the earth, subterranean pipelines, and aboveground pipelines. In order to effectively manage the production systems, performance of the conduits and conditions within them must be monitored on a regular basis. Thus, many conduits are designed with a number of permanently installed sensors and detection devices used to measure various attributes of the fluid or gas flowing therein.

Historically, these measurements have been made with conventional detection systems, which are installed at the initial construction of the well or pipeline or in special side pockets designed for replaceable detection equipment. In the recent past, the side pocket systems have been less utilized in favor of more complex wired detection systems. These systems are permanently assembled in to the structure of the well or pipeline and in the event of failure, in the case of a well, the entire production tubular string has to be pulled requiring a substantial work over rig, or in the case of subterranean pipelines, excavated and replaced using heavy construction equipment.

Today, perhaps as many as 10% of all the detection systems installed downhole in oilfields eventually fail. In some cases, all the detection systems in a field fail leaving the operator blind to operating conditions. Thus, there is a need for retrofit instrumentation, which can be installed in these conduits despite their sometimes being buried in the earth or located in inaccessible places.

The retrofit instrumentation should also include a reliable wireless communication system for communicating information to the surface and a power source capable of facilitating that communication. Since the earliest work on wireless communication, practitioners have sought to use an electrical dipole to induce an electrical field in the earth or current along the metallic structure of the well casing or pipeline. For example, such instrumentation may comprise an elongate body having one or more electrodes spaced some distance apart along the body. The electrodes are placed in contact with the conduit and a signal may be passed to and from the instrumentation and the conduit.

In order to maximize the power delivered to the communication channel, sufficient force must be used to embed the electrodes into the wall of the metallic structure, i.e. the conduit. To ensure that the electrodes are sufficiently embedded into the well casing or pipeline, some operators use conventional oilfield anchoring devices (packers/slips) to serve both as the electrical contacts with the conduit and to secure the measuring device within the conduit. There is however a serious weakness to this design.

During the operation of a well or fluid conduit, it is common to interrupt the flow of fluids for various reasons including testing and maintenance. The relatively sudden reduction in flow can have a substantial temperature impact on the measuring device and its anchoring systems. In the case of an injection well, normally pumping cold seawater, a sudden interruption of fluid flow can raise the temperature by more than 50° C.

Because the retrofit instrumentation device is secured at two fixed locations by the packers/slips, a 50° C. change in temperature can produce an axial strain in the measuring device in excess of 80,000 pounds. Often, this strain is sufficient to cause the release mechanism of common packers, i.e., shear pins, to fail and/or disrupt the nature of the electrical contact, allowing fluid and corrosion access to the contact electrodes. Any corrosion or change in the electrical characteristics of the contact electrodes can have a debilitating effect on the ability to deliver electrical power to the conduit. In the worst case, the anchor/electrode system can fail completely allowing the tool to fall further into the well, or be blown out by production fluids.

Accordingly, oil and gas systems and methods could benefit from improved devices and techniques for retrofitting instrumentation within a live production environment, reducing the likelihood of damage to equipment during a thermal event, and wirelessly transmitting and receiving information to the surface.

### SUMMARY OF THE DISCLOSURE

In accordance with certain embodiments of the present disclosure, devices and methods for use within a live oil or gas production environment are disclosed. The device may comprise an electronics vessel comprising one or more sensors for sensing properties of interest within a conduit. The device may further comprise a power source, a setting component for setting the device within the conduit, and at least one electrical contact component. In some embodiments, the setting component may be configured to serve as a second electrical contact component. In other embodiments, a second electrical contact component independent of the setting component may be provided. The electrical contact components may be placed in contact with the conduit to create an electrical contact at the interfaces therebetween.

In one aspect, the device may further comprise a strain-reducing component for preventing strain at the first and second interfaces when the measuring device undergoes a thermal expansion or is exposed to a thermal event. In one embodiment, the strain-reducing component may comprise an expansion joint. In other embodiments, the strain-reducing component may comprise a flexible electrode assembly coupled to one of the electrical contact components and configured to translate along a central axis of the apparatus. In further embodiments, the device may comprise a retractable electrode assembly housing one or more of the electrical contact components. The retractable electrode assembly may be configured to selectively or automatically retract the one or more electrical contact components in certain circumstances.

Additional objects and advantages of the present disclosure will be set forth in part in the description which follows, and in part will be obvious from the description, or may be learned by practice of the disclosure. The objects and advantages of the disclosure will be realized and attained by means of the elements and combinations particularly pointed out in the appended claims.

It is to be understood that both the foregoing general description and the following detailed description are exemplary and explanatory only and are not restrictive of the claims.

The accompanying drawings, which are incorporated in and constitute a part of this specification, illustrate several embodiments and together with the description, serve to explain the principles of the disclosure.

### BRIEF DESCRIPTION OF THE DRAWINGS

FIG. 1 depicts some aspects of an exemplary embodiment of a system as described herein.

FIG. 2 depicts an exemplary embodiment of a computing system as described herein.

FIG. 3 depicts some aspects of an exemplary embodiment of a system as described herein.

FIG. 4 depicts some aspects of an exemplary embodiment of a system as described herein.

FIG. 5 depicts some aspects of an exemplary embodiment of a system as described herein.

FIG. 6 depicts some aspects of an exemplary embodiment of a system as described herein.

FIG. 7 depicts some aspects of an exemplary embodiment of a system as described herein.

FIG. 8 depicts some aspects of an exemplary embodiment of a system as described herein.

FIG. 9 depicts some aspects of an exemplary embodiment of a system as described herein.

FIG. 10 depicts some aspects of an exemplary embodiment of a system as described herein.

FIG. 11 depicts some aspects of an exemplary embodiment of a method as described herein.

FIG. 12 depicts some aspects of an exemplary embodiment of a system as described herein.

### DESCRIPTION OF EXEMPLARY EMBODIMENTS

Disclosed herein are various embodiments of a retrofit measuring device for use in oil and gas production environments. Generally, the device can be lowered and secured to a production conduit such as a well casing or pipeline, measure attributes of fluids or gases within the conduit, receive information from the surface, and transmit information to the surface. Currently employed retrofit devices commonly use a pair of fixed anchoring devices spaced some distance apart along the elongate body of the device. The anchoring devices serve to both secure the device within the conduit and provide electrical contacts with the conduit. Interruptions in the flow of fluid and/or gas within the pipeline can lead to thermal events during which the temperature inside the conduit quickly increases. The sudden change in temperature may cause a thermal expansion of the measuring device. Because the measuring device is fixed at two locations along its body, this thermal expansion creates an axial strain sufficient to alter or damage one or more anchoring devices. As a result, the measuring device may not be adequately secured within the conduit and/or the anchoring systems may not be in sufficient contact with the conduit to reliably communicate information to the surface. Thus, current measuring devices are not ideally suited for retrofitting within a live production environment.

The devices, systems, and methods disclosed herein solve these problems by introducing elements of consumer presence detection, demographic and behavior information collection, and the facilitation of real-time transactions for the display of advertisements at advertising space within view of the detected consumer. Moreover, in situations where more than one consumer is within view of the advertising space, marketers can decide, in real-time, whether to display an advertisement targeting one of the consumers within a group, or display an advertisement targeted at the group as a whole or some subset of the group.

While the devices, systems, and methods described herein are primarily concerned with the retrofitting of a measuring device within an oil or gas production environment, one skilled in the art will appreciate that the devices, systems, and methods described below can be used in other contexts, including the original construction of the conduits for use in oil or gas production.

Reference will now be made in detail to certain exemplary embodiments, examples of which are illustrated in the accompanying drawings. Wherever possible, the same reference numbers will be used throughout the drawings to refer to the same or like items.

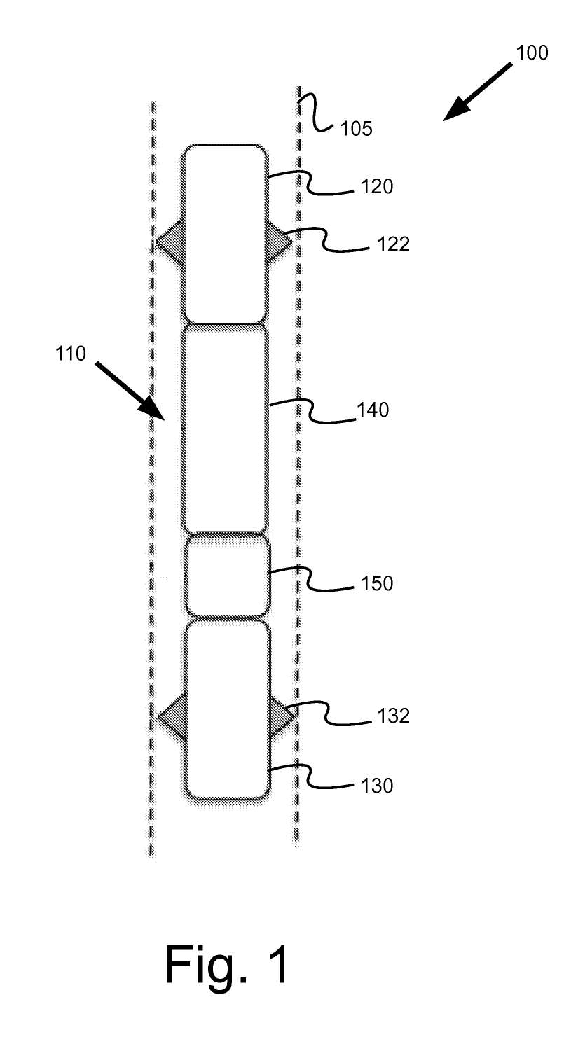

FIG. 1 illustrates one exemplary embodiment of a system 100. System 100 comprises a conduit 105 and a measuring device 110. Generally, measuring device 110 may be configured to detect or otherwise measure a number of attributes pertaining to a fluid or gas within conduit 105, transmit information to the surface or an operator outside the conduit, and receive information from the surface or the operator outside the conduit.

In one embodiment, conduit 105 may comprise a well casing residing within a subterranean well bore for oil or gas production. In other embodiments, conduit 105 may be a subterranean or aboveground pipeline for transporting oil or gas. As depicted in FIG. 1, conduit 105 is substantially tubular having an inner diameter and an outer diameter. In other embodiments, however, conduit 105 may be some other shape. For example, conduit 105 may exhibit a square, rectangular, or triangular cross section. In further embodiments, conduit 105 may exhibit any cross sectional shape corresponding to the well bore in which it resides and/or suitable for transporting oil or gas.

In another aspect, conduit 105 can exhibit sufficient structural strength to prevent the caving in of the well bore in which it resides, as well as contain any pressures exerted on it by a fluid or gas flowing therein. In one embodiment, conduit 105 may comprise an electrically conductive metallic structure. Any suitable conductive material, such as steel, may be used. Conduit 105 may be comprised entirely of the electrically conductive metallic material. Alternatively, only a portion of conduit 105 may be comprised of the electrically conductive metallic material in order to facilitate signaling between the surface and downhole locations.

Measuring device 110 may comprise a first anchor system 120, a second anchor system 130, an electronics vessel 140, and a flexible coupling 150. In one aspect, measuring device 110 may be a tubular structure having an inner diameter and an outer diameter. In use, measuring device 110 may be lowered into conduit 105 and fluids or gases flowing within conduit 105 may flow through measuring device 110. Alternatively, measuring device may be cylindrical in shape and fluids and/or gases within conduit 105 may flow around measuring device 110. Of course, measuring device 110 may be any other suitable shape configured to allow fluids or gases within conduit 105 to flow through or around it.

In one embodiment, first and second anchor systems 120, 130 each comprise an electrode setting component 122, 132, respectively, comprising one or more electrodes and having a conventional structure known and commonly used in the oil and gas industry for setting tools within a conduit. Generally, each electrode setting component may comprise a plurality of teeth that can be forced into surrounding conduit 105 using wedges. Various methods for setting the teeth into conduit 105 exist, including the use of pyrotechnic, hydraulic, and atmospheric sources of force. The particular structure of electrode setting components 122, 132 and the methods for forcing them into conduit 105 described above are only exemplary, and any suitable electrode setting structure and/or method of setting anchor systems 120 and 130 into conduit 105 may be used.

The electrode setting components may be electrically conductive and set into conduit 105 so as to create sufficient contact with conduit 105 not only to support the weight of measuring device 110 within conduit 105 and resist forces exerted on it by fluids or gases within conduit 105, but also to ensure a relatively low impedance electrical contact between the electrode setting components 122, 132 and conduit 105.

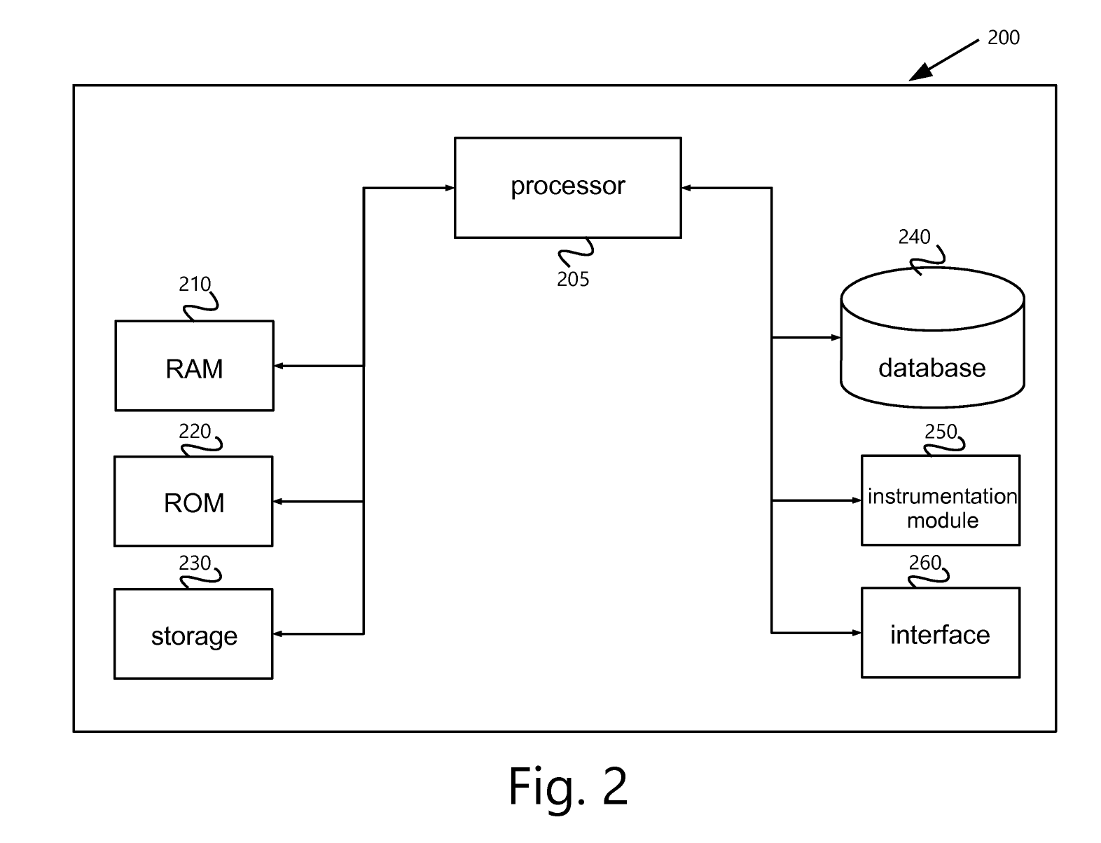

Measuring device 110 may further comprise an electronics vessel 140. Electronics vessel 140 may contain a number of sensors, gauges, and other measuring instrumentation helpful in gathering information regarding a downhole environment. For example, electronics vessel 140 may contain sensors for detecting the pressure, temperature, and other attributes of a fluid or gas flowing within the conduit. In addition to various measuring instrumentation, electronics vessel 140 may comprise actuating components for controlling other equipment within the conduit, as well as a processor- or controller-based computer system for interpreting, analyzing, transmitting, and receiving data. Further details regarding an exemplary computer system are described below with respect to FIG. 2.

In another aspect, measuring device 110 may comprise a flexible coupling 150 located between anchor systems 120 and 130. Coupling 150 may comprise any suitable structure that facilitates electrical signaling therethrough while affording relief of any thermally induced strain, and thus, allowing electrode setting components 125, 135 to remain undisturbed by any resulting thermal expansion of measuring device 110. In one embodiment, coupling 150 may be an expansion joint comprising any suitable conductive material for facilitating transmission of an electric signal between anchor systems 120 and 130. In such an embodiment, the expansion joint may be, for example, mechanical or hydraulic in nature. Further, the expansion joint may comprise upper and lower portions that mate along a plurality of opposing, elongate teeth that remain in contact with one another despite having the ability to move towards and away from one another. Alternatively, the expansion joint may comprise a flexible sleeve of non-conductive material with conductive wiring or pathways embedded therein for the transmission of electrical signals therethrough. In further embodiments, the expansion joint may comprise a flexible sleeve of conductive or non-conductive material and may or may not house and/or protect wiring therein. Of course, the examples of expansion joints described herein are only exemplary, and any suitable expansion joint that affords measuring device 110 a degree of freedom between anchor systems 120 and 130 in case of a thermal event while still facilitating electrical signaling between the anchor systems may be used.

In use, a signal may be applied to the metallic structure of conduit 105 at the surface of the production rig. The signal may be transmitted along the length of conduit 105 and flow into measuring device 110 at electrode setting component 125. Presuming a sufficiently low impedance, the signal can then flow from electrode setting component 125 and anchor system 120 to anchor system 130 and electrode setting component 135, and back to the metallic structure of conduit 105. Between electrode setting components 125 and 135, the signal may flow through electronics vessel 140 wherein one or more components may detect, measure, and/or analyze the signal. In this manner, measuring device is able to receive information transmitted from the surface.

During a thermal event that causes an expansion of one or more components of measuring device 100, any displacement may be absorbed by flexible coupling 150 and the electrical contacts at anchor systems 120, 130 may remain undisturbed.

In other embodiments, electronics vessel 140 may further comprise a power source for generating signals and a transmitter for transmitting information back to the surface. The signals can be processed within a processor- or controller-based system of electronics vessel 140 and communicated along a similar transmission path as that described for receiving signals from the surface.

FIG. 2 depicts an exemplary processor-based computing system 200 representative of the type of computing system that may be present in electronics vessel 140. The computing system 200 is exemplary only and does not exclude the possibility of another processor- or controller-based system being used in electronics vessel 140.

In one aspect, system 200 may include one or more hardware and/or software components configured to execute software programs, such as software for storing, processing, and analyzing data. For example, system 200 may include one or more hardware components such as, for example, processor 205, a random access memory (RAM) module 210, a read-only memory (ROM) module 220, a storage system 230, a database 240, one or more input/output (I/O) modules 250, and an interface module 260. Alternatively and/or additionally, system 200 may include one or more software components such as, for example, a computer-readable medium including computer-executable instructions for performing methods consistent with certain disclosed embodiments. It is contemplated that one or more of the hardware components listed above may be implemented using software. For example, storage 230 may include a software partition associated with one or more other hardware components of system 200. System 200 may include additional, fewer, and/or different components than those listed above. It is understood that the components listed above are exemplary only and not intended to be limiting.

Processor 205 may include one or more processors, each configured to execute instructions and process data to perform one or more functions associated with system 200. The term “processor,” as generally used herein, refers to any logic processing unit, such as one or more central processing units (CPUs), digital signal processors (DSPs), application specific integrated circuits (ASICs), field programmable gate arrays (FPGAs), and similar devices. As illustrated in FIG. 2, processor 205 may be communicatively coupled to RAM 210, ROM 220, storage 230, database 240, I/O module 250, and interface module 260. Processor 205 may be configured to execute sequences of computer program instructions to perform various processes, which will be described in detail below. The computer program instructions may be loaded into RAM for execution by processor 205.

RAM 210 and ROM 220 may each include one or more devices for storing information associated with an operation of system 200 and/or processor 205. For example, ROM 220 may include a memory device configured to access and store information associated with system 200, including information for identifying, initializing, and monitoring the operation of one or more components and subsystems of system 200. RAM 210 may include a memory device for storing data associated with one or more operations of processor 205. For example, ROM 220 may load instructions into RAM 210 for execution by processor 205.

Storage 230 may include any type of storage device configured to store information that processor 205 may need to perform processes consistent with the disclosed embodiments.

Database 240 may include one or more software and/or hardware components that cooperate to store, organize, sort, filter, and/or arrange data used by system 200 and/or processor 205. For example, database 240 may include user-specific account information, predetermined menu/display options, and other user preferences. Alternatively, database 240 may store additional and/or different information.

Instrumentation module 250 may include one or more sensors, gauges, and/or instrumentation components configured to detect, record, and/or communicate information to a user associated with system 200. For example, I/O module 250 may include a pressure sensor, a temperature sensor, and any other suitable sensor for providing useful information associated with system 200.

Interface 260 may include one or more components configured to transmit and receive data via a communication channel. For example, interface 260 may include one or more modulators, demodulators, multiplexers, demultiplexers, network communication devices, wireless devices, antennas, and any other type of device configured to enable data communication via a communication channel.

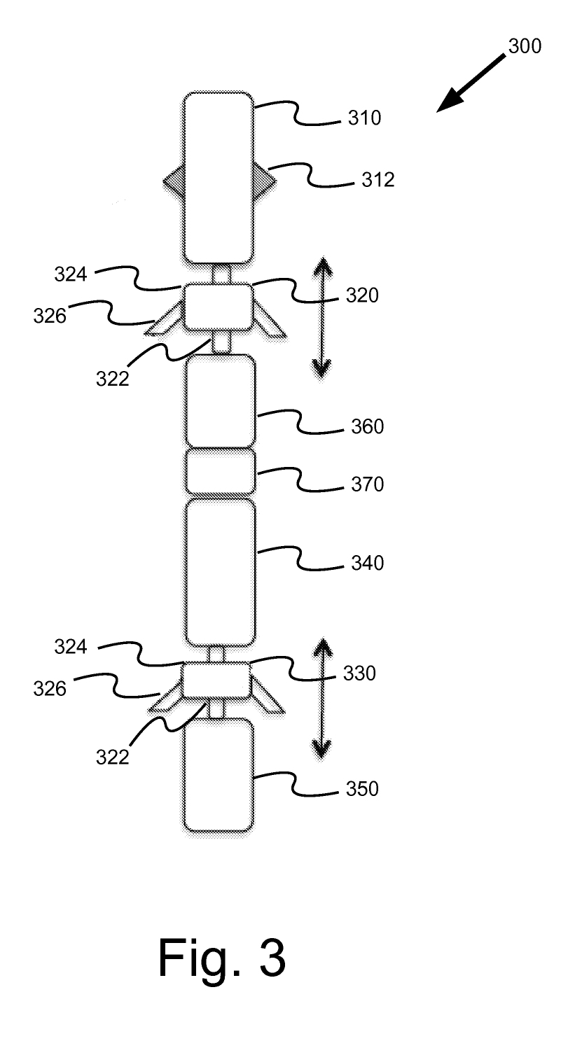

FIG. 3 depicts an alternative measuring device 300. In one aspect, measuring device 300 may comprise an anchor system 310, a first flexible electrode assembly 320, a second flexible electrode assembly 330, an electronics vessel 340, and a power source 350. Measuring device 300 may further optionally comprise a conductive spacer 360 comprising a material exhibiting a high degree of electrical conductivity and a flexible coupling 370 substantially similar to the flexible coupling described above with respect to FIG. 1.

Power source 350 may be any suitable power source, including a turbine or a battery system. The power generated by power source 350 can be used to power the circuitry within electronics vessel 340 which is substantially similar to electronics vessel 140 discussed above with respect to FIG. 1 and may contain components substantially similar to those discussed above with respect to FIG. 2.

Like measuring device 110 described above, measuring device 300 may be configured to detect or otherwise measure a number of attributes pertaining to a fluid or gas within conduit 105, transmit information to the surface or an operator outside the conduit, and receive information from the surface or an operator outside the conduit. Unlike measuring device 110, however, anchor system 310 may not necessarily comprise electrodes for establishing electrical connectivity with conduit 105. Rather, anchor system 310 may comprise a setting component 312 commonly used in the industry for setting a device within a conduit. Like electrode setting components 125 and 135 described above, setting component 312 may comprise a plurality of teeth that can be forced into surrounding conduit 105 using wedges. The particular structure of setting component 312 and the methods for forcing it into conduit 105 are not critical. Any suitable setting structure and/or method of setting anchor system 310 into conduit 105 may be used in order to create sufficient contact with conduit 105 to support the weight of measuring device 300 within conduit 105 and resist forces exerted on it by fluids or gases within conduit 105.

In another aspect, measuring device 300 may comprise a pair of flexible electrode assemblies 320 and 330. In an operating environment, flexible electrode assemblies 320 and 330 can establish an electrical connection between measuring device 300 and conduit 105 that may remain undisturbed even in instances where measuring device 300 undergoes some degree of thermal expansion as a result of a thermal event. This is accomplished using structure that affords flexible electrode assemblies 320 and 330 a degree of freedom with respect to measuring device 300 rather than being fixedly coupled to measuring device 300.

In one embodiment, each flexible electrode assembly may comprise an actuator rod 322, 332, respectively. Actuator rods 322, 332 may be solid, elongate members comprising a conductive material capable of transmitting an electrical signal. In other embodiments, actuator rods 322, 332 may be tubular structures having a hollow center through which fluids or gases may flow, and/or connective wiring may be located.

Each actuator rod may slidingly engage a respective shoe deployment ring 324, 334. Shoe deployment rings 324, 334 may be solid or hollow donut-like structures through which actuator rods 322, 332 pass. In one aspect, shoe deployment rings may comprise a conductive material capable of transmitting an electrical signal. Alternatively or additionally, shoe deployment rings 324, 334 may house wiring for the transmission of electrical signals. In another aspect, while shoe deployment rings 324, 334 are slidingly engaged with actuator rods 322, 332, sufficient contact between the components exists to afford a low impedance electrical connection at an interface between the two components.

In a further aspect, each shoe deployment ring may comprise one or more electrode arms 326, 336. In one embodiment, electrode arms 326, 336 may comprise an elongate member extending from a proximate end adjacent shoe deployment rings 324, 334 to a distal end extending toward conduit 105. Electrode arms 326, 336 may be coupled to their respective shoe deployment ring at, for example, a pivot point located at the proximate end of each electrode arm in order to allow each electrode arm to rotate relative to measuring device 300. In this manner, electrode arms 326, 336 may be energized to contact conduit 105, allowing for the transmission of electrical signals to and from the surface in a manner similar to that described above with respect to electrode setting components 125, 135 in FIG. 1. In other embodiments, electrode arms 326, 336 may be coupled to their respective shoe deployment ring in another manner. For example, electrode arms 326, 336 may be coupled to shoe deployment rings 324, 334, respectively, using springs and the electrode arms may be spring urged towards conduit 105. Alternatively, electrode arms 326, 336 may be set in a vertical channel within their respective shoe deployment rings, each vertical channel having a variable depth such that as each electrode arm moves up or down within the channel, the distal end of each electrode arm moves toward or away from conduit 105. Other embodiments are also possible, and any suitable method or structure that facilitates selective or automated movement of the distal ends of electrode arms 326, 336 toward and away from conduit 105 may be used. In still further embodiments, electrode arms 326, 336 may be fixedly coupled to shoe deployment rings 324, 334.

In use, measuring device 300 may be lowered to an appropriate location within conduit 105 and secured within the conduit via one or more of anchor system 310 and flexible electrode assemblies 320, 330. As described above with respect to FIG. 1, two or more of anchor system 310 and flexible electrode assemblies 320, 330 may also be in electrical communication with electronics vessel 340 and/or power source 350 in order to facilitate transmission and/or reception of electrical signals to and from the surface. In the event of a sudden temperature change during which measuring device 300 undergoes some degree of thermal expansion, shoe deployment rings 324, 334 (and electrode arms 326, 336) are free to slide along actuator rods 322, 332. As a result, no thermal strain develops at any of the electrical contacts established at one or more of setting component 312 and electrode arms 326, 336.

Of course, alternative structure that affords flexible electrode assemblies 320, 330 a degree of freedom with respect to measuring device 300 are also possible. For example, rather than solid or hollow actuator rods 322, 332, shoe deployment rings 324, 334 of flexible electrode assemblies 320, 330 may be maintained between a pair of springs that allow the shoe deployment rings to oscillate along an axis substantially parallel to the elongate body of measuring device 300. Other suitable structure may also be used and the examples provided herein are only exemplary.

Further, it should be noted that in embodiments where anchor system 310 comprises one or more electrodes, measuring device 300 may comprise more than two sets of electrodes for establishing electrical contact with conduit 105. This can be advantageous in situations where one or more locations within conduit 105 are not ideal for electrical transmission. Thus, once measuring device 300 is positioned within conduit 105, if one of anchor system 310 and flexible electrode assemblies 320, 330 cannot establish a reliable electrical connection with conduit 105, the remaining electrodes can be used. As depicted in FIG. 3, measuring device 300 comprises three possible sets of one or more electrodes (anchor system 310 and flexible electrode assemblies 320, 330), however other embodiments are possible comprising two or more anchor systems 310 and/or three or more flexible electrode assemblies.

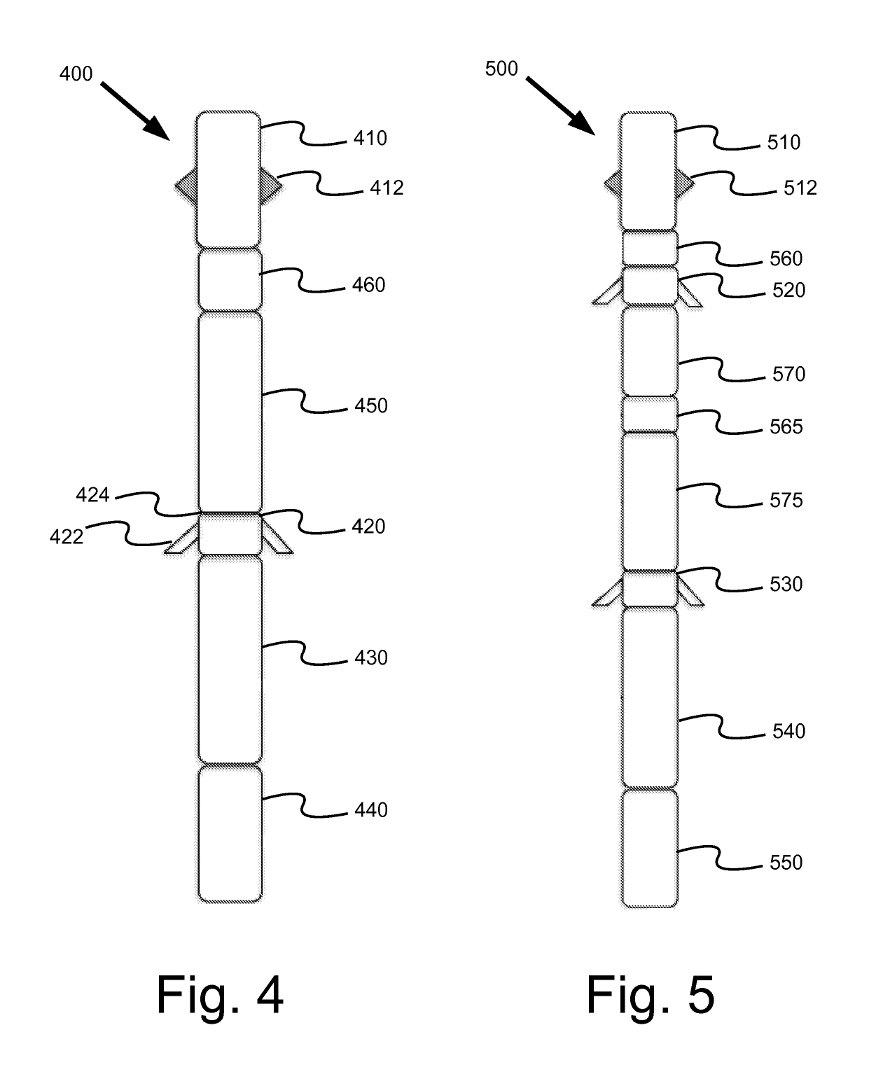

FIG. 4 depicts another exemplary embodiment of a measuring device 400. Measuring device 400 may comprise an anchor system 410, an electrode assembly 420, an electronics vessel 430, a power source 440, and optionally a conductive spacer 450. In one aspect, anchor system 410 may comprise setting component 412 and may function substantially similar to anchor system 120 described above with respect to FIG. 1. Likewise, electronics vessel 430, power source 440, and conductive spacer 450 may comprise substantially similar structure and exhibit substantially similar function to corresponding components described above with respect to FIGS. 1-3.

In another aspect, electrode assembly 420 may comprise one or more electrode arms 422 substantially similar to electrode arms 326, 336 described above with respect to FIG. 3. Additionally, electrode arms 422 may be coupled to a main body 424 of electrode assembly 420 in a manner substantially similar to that described above with respect to electrode arms 326, 336 and shoe deployment rings 324, 334. However, rather than main body 424 being mounted on an actuator bar or otherwise afforded a degree of freedom with respect to the remainder of measuring device 400, a flexible coupling 460 substantially similar to flexible coupling 150 described above with respect to FIG. 1 may be interposed between anchor system 410 and electrode assembly 420.

During a thermal event that causes an expansion of one or more components of measuring device 400, any displacement of the components may be absorbed by flexible coupling 460 and the electrical contacts at anchor system 410 and/or electrode assembly 420 may remain undisturbed.

FIG. 5 depicts an alternative embodiment of measuring device 500. Measuring device 500 may comprise an anchor system 510, an electrode assembly 520, an electronics vessel 540, a power source 550, a flexible coupling 560 interposed between anchor system 510 and electrode assembly 520, and optionally a conductive spacer 570. Measuring device 500 is substantially similar to device 400 depicted in FIG. 4 with the exception that device 500 may further comprise an additional electrode assembly 530 and an additional flexible coupling 565 interposed between electrode assemblies 520, 530.

As discussed above with respect to other embodiments, a reliable electrical connection cannot always be established at every location along conduit 105. As a result, it may be beneficial to provide measuring device 500 with additional potential electrical contact points. Nonetheless, in order to avoid thermal strain resulting from a thermal event from interrupting one or more electrical contacts established by device 500 with conduit 105, additional flexible coupling 565 may be interposed between electrode assemblies 520, 530 in order to absorb any expansion/displacement of one or more components of measuring device 500.

Again, as discussed previously, rather than using a combination of an electrode assembly and a flexible coupling, a flexible electrode assembly substantially similar to those described above with respect to FIG. 3 can be substituted for one or more of electrode assemblies 520, 530, and optionally flexible couplings 560, 565.

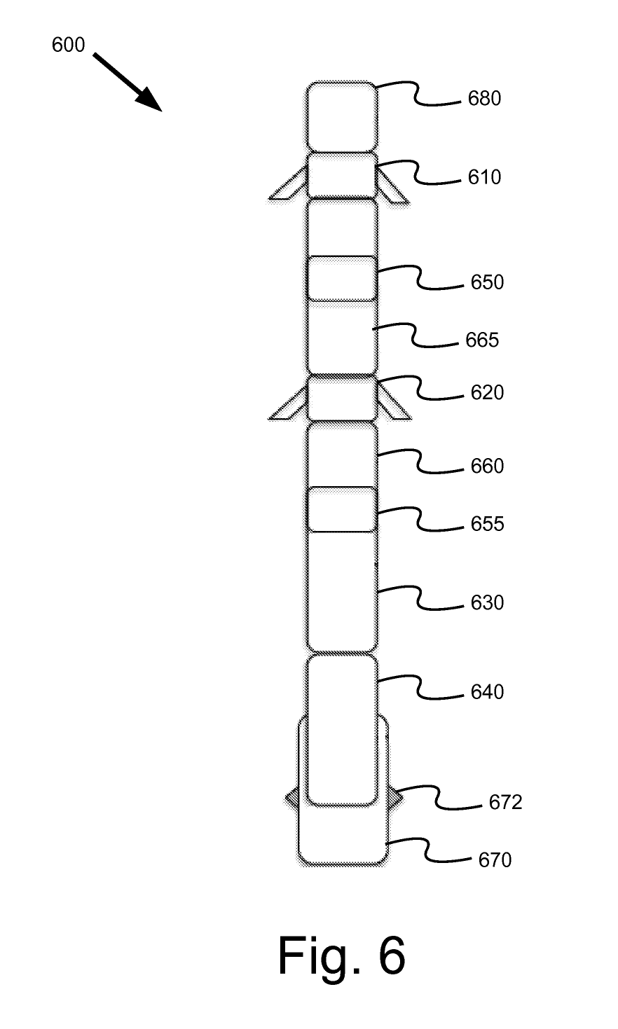

Another measuring device 600 is depicted in FIG. 6. Device 600 may comprise a first electrode assembly 610, a second electrode assembly 620, an electronics vessel 630, a power source 640, a pair of flexible couplings 650, 655, and optionally a pair of conductive spacers 660, 665. These components are substantially similar to those described above with respect to previous embodiments. It should also be clear that one or more combinations of electrode assemblies 610, 620 and flexible couplings 650, 655 can be substituted for a flexible electrode assembly as described above with respect to FIG. 3.

Device 600 may further comprise a receptacle system 670 and a retrieval component 680. In one aspect, receptacle system 670 may serve substantially the same function as anchor systems 120, 310, and 410 described above with respect to previous embodiments, supporting some, most or all of the weight of device 600 within conduit 105. Further, like the aforementioned anchor systems, receptacle system 670 may comprise a setting component 672 for securing receptacle system 670 to conduit 105. Setting component 672 may or may not comprise one or more electrodes and serve as an optional point of electrical connectivity.

In one embodiment, receptacle system 670 may be a polished bore receptacle. In use, receptacle system 670 may be lowered into conduit 105 and secured within the conduit prior to lowering the remainder of device 600 into the casing. The remainder of device 600 may then be lowered into conduit 105, inserted into receptacle system 670, and locked into place. Depending upon whether setting component 672 is relied upon to establish an electrical connection with conduit 105, receptacle system 670 may or may not comprise electrical connectivity means for electrically coupling setting component 672 to power source 640 or some other component of device 600.

In another aspect, retrieval component 680 may be positioned atop device 600 and provide structure for securing and/or retrieving device 600 from conduit 105. Any known, suitable structure may be appropriate, including a loop, a hook, magnetic means, or some other appropriate structure. In FIG. 6, retrieval component 680 is depicted atop device 600. In alternative embodiments, however, retrieval component 680 may be located at any suitable location along the elongate body of measuring device 600.

As is the case with the aforementioned embodiments, device 600 may withstand axial strains resulting from a thermal event due to the interposition of flexible coupling 650 between electrode assemblies 610 and 620, and the interposition of flexible coupling 655 between electrode assembly 620 and receptacle system 670 that serve to absorb displacements within the elongate body of device 600 when it undergoes thermal expansion. Thus, electrical connectivity at electrode assemblies 610, 620 and/or receptacle system 670 may remain undisturbed. Furthermore, and as mentioned above, flexible electrode assemblies substantially similar to those described above with respect to FIG. 3 may be substituted for electrode assemblies 610, 620, and optionally flexible couplings 650, 655.

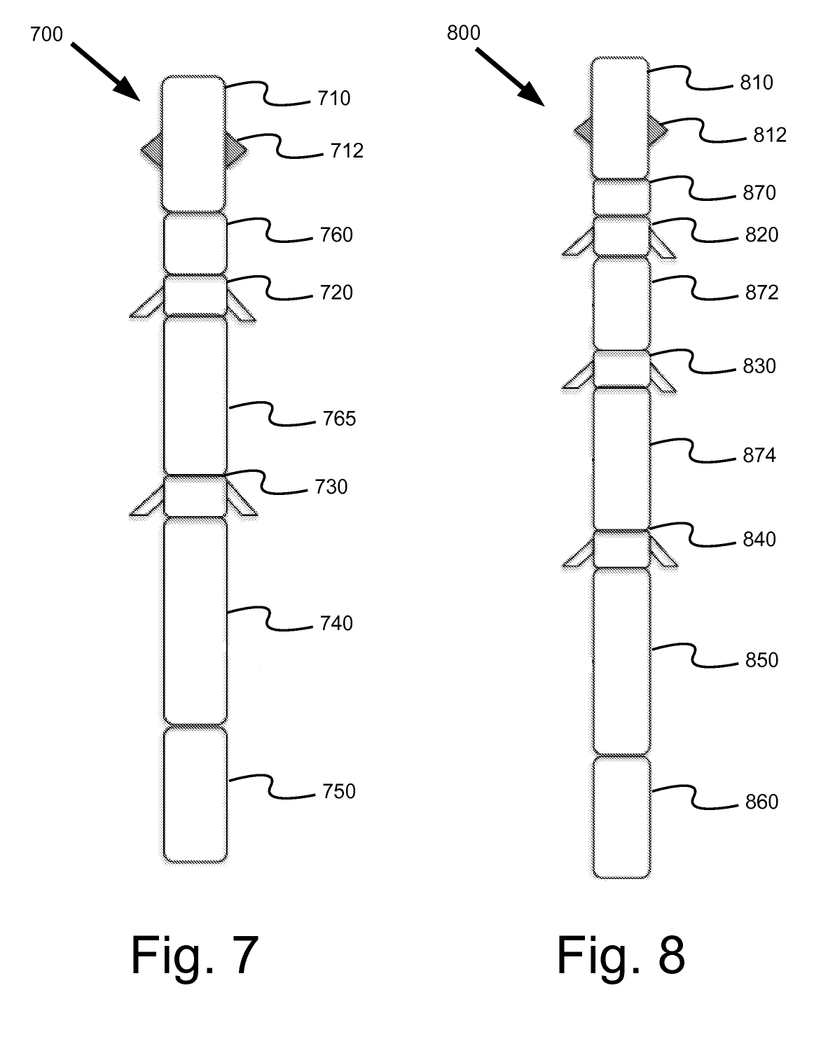

FIG. 7 depicts another measuring device 700 for preventing thermal strain resulting from a thermal event from disrupting electrical connections with conduit 105. In one aspect, measuring device 700 may comprise an anchor system 710, an electrode assembly 720, an electrode assembly 730, an electronics vessel 740, and a power source 750. Device 700 may further comprise optional conductive spacers 760 and 765. As discussed above with respect to previous embodiments, anchor system 701 may comprise a setting component 712 that may or may not comprise one or more electrodes for serving as an optional electrical connection location between device 700 and conduit 105.

Absent from the embodiment depicted in FIG. 7 are any flexible couplings and/or flexible electrode assemblies described above with respect to other embodiments. Rather, in order to prevent thermal strain from disrupting electrical connections between device 700 and conduit 105, electrode assemblies 720, 730 may comprise one or more retractable electrodes that can be automatically or selectively retracted away from conduit 105 during a thermal event or prior to a thermal event. Of course, the one or more electrodes may also be automatically or selectively protracted toward conduit 105 either during installation of device 700 or to reestablish electrical contact with conduit 105 following a thermal event.

One exemplary embodiment of a retractable electrode assembly is described in more detail with respect to FIG. 9. However, it should be noted that any suitable structure and/or method for automatically or selectively retracting one or more electrodes away from conduit 105 in response to a detected condition or command can be used. Additionally, though the embodiment depicted in FIG. 7 comprises a pair of retractable electrode assemblies 720, 730, any of the electrode assemblies described above with respect to other embodiments can be substituted for one or both of the retractable assemblies, including a flexible electrode assembly and/or a combination of an electrode assembly and a flexible coupling.

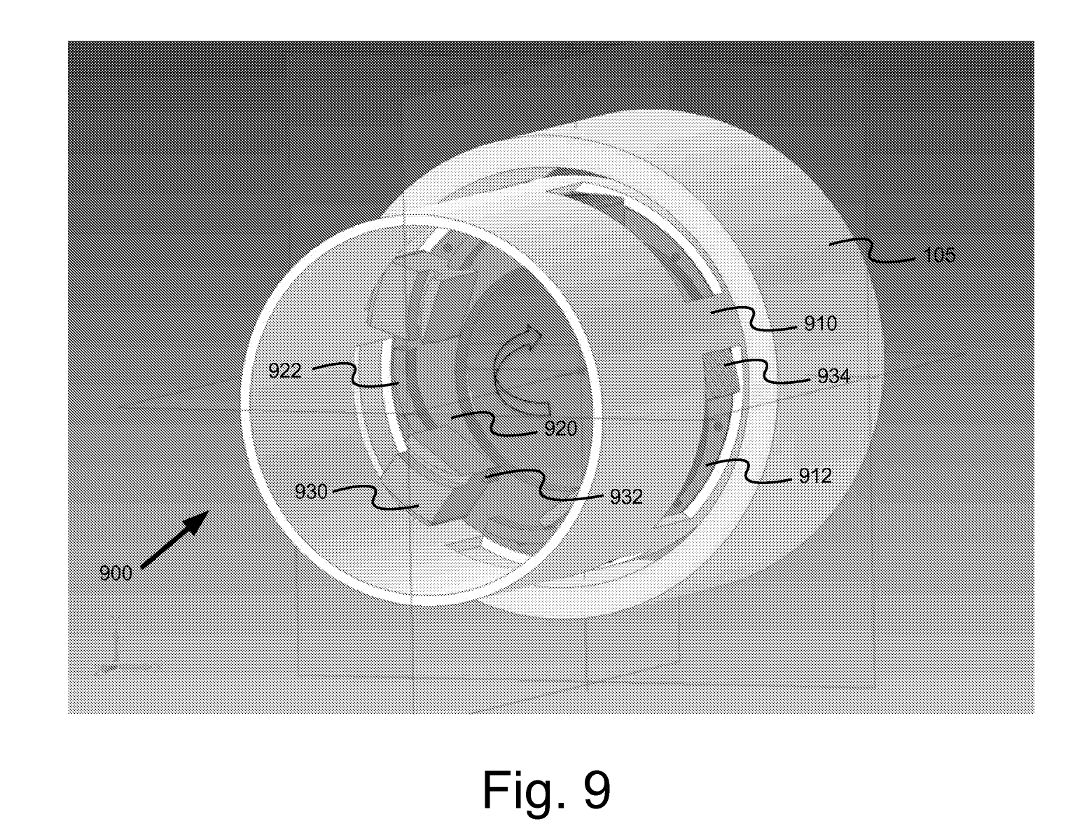

FIG. 8 depicts another measuring device 800. Measuring device 800 may comprise an anchor system 810, retractable electrode assemblies 820, 830, an electronics vessel 850, a power source 860, and optionally a pair of conductive spacers 870, 872. Measuring device 800 may be substantially similar to measuring device 700 of FIG. 7, however, measuring device 800 may further comprise an additional retractable electrode assembly 840, and optionally an additional conductive spacer 874. Some reasons one may desire to include additional electrode assemblies along the elongate body of measuring device 800 are discussed above. Further, it should be appreciated that any number of electrode assemblies (including retractable electrode assemblies, flexible electrode assemblies, and/or a combination of an electrode assembly and a flexible coupling) can be implemented and spaced along measuring device 800, including embodiments with four or more electrode assemblies.

FIG. 9 depicts a more detailed view of one exemplary embodiment of a retractable electrode assembly. In one aspect, retractable electrode assembly 900 may comprise a main body 910, a drive component 920, and one or more electrodes 930. In one embodiment, electrodes 930 may comprise a slot 932 for mating with a protruding drive rail 922 of drive component 920 in such a manner that each electrode 930 may be slidingly associated with a respective drive rail 922. Further, protruding drive rail 922 may be arced or otherwise configured such that as electrode 930 slides along the length of the drive rail, it moves towards or away from the outer wall of main body 910. In use, a rotation imparted to drive component 920 may result in the relative movement of one or more electrodes 930 toward and/or away from the outer wall of main body 910.

In another aspect, main body 910 may comprise one or more electrode windows 912 corresponding to each electrode 930. In this manner, as each electrode 930 slides along its respective drive rail 922 and approaches the outer wall of main body 910, each electrode may be allowed to pass through main body 910 so as to achieve a protracted state. In particular, each electrode 930 may comprise an electrode face 934 that may protrude through its respective electrode window 912 and contact the inner surface of conduit 105, in which main body 910 has been positioned.

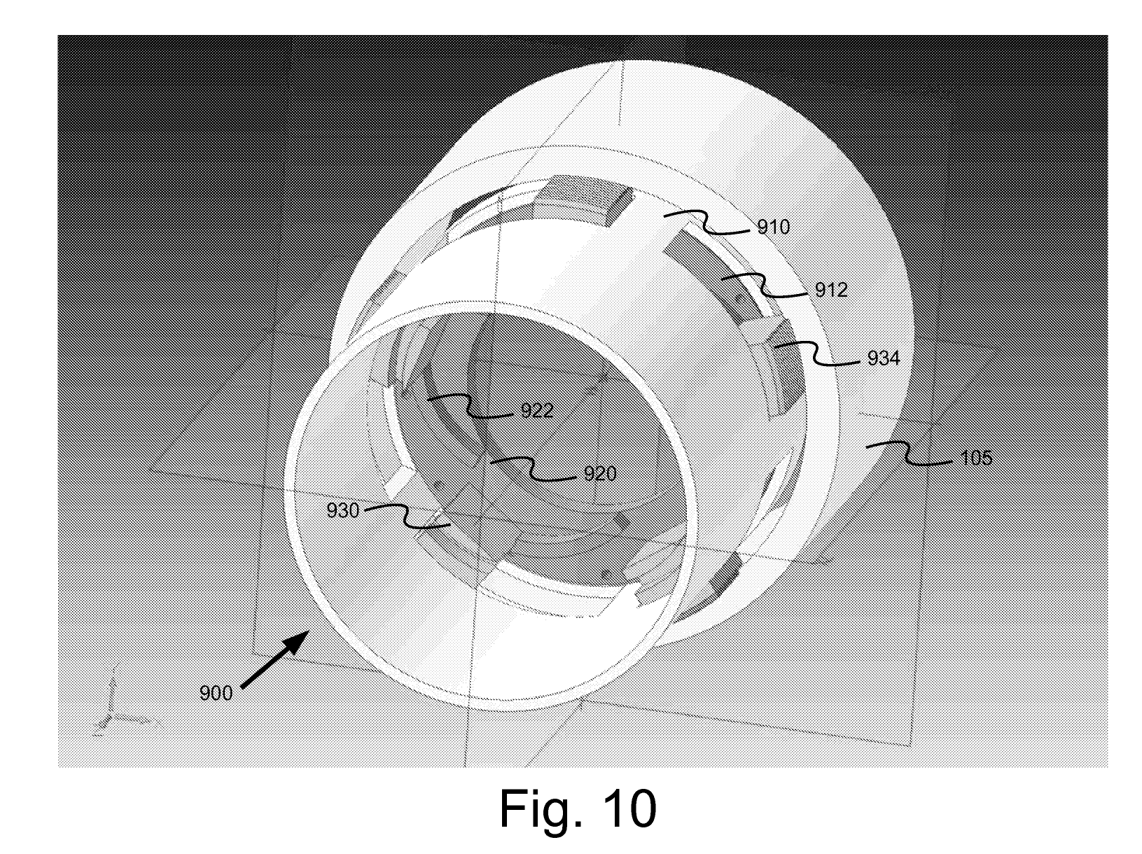

In a further aspect, each electrode 930 and its corresponding electrode face 934 can exert sufficient force against conduit 105 so as to secure electrode assembly (and the measuring device of which it may be a part) within conduit 105 and/or establish a reliable electrical contact with conduit 105. A view of retractable electrode assembly 900 during which one or more electrodes 930 are set to a protracted position is depicted in FIG. 10.

In a further aspect, where a thermal event is either detected or predicted, drive component 920 can be rotated in an opposite direction causing one or more electrodes to slide the other direction along its respective drive rail 922 resulting in the relative movement of the electrodes 930 away from conduit 105 and/or back through electrode window 912. The detection or prediction of a thermal event can be accomplished in any number of ways. For example, one or more components within an electronics vessel of any of the aforementioned measuring devices can be used to detect, analyze, and/or conclude that a thermal event is likely to occur, is occurring, or will occur. Alternatively, a determination regarding an ongoing or impending thermal event can be made by other equipment within the conduit or at the surface by operators.

Upon detection of an impending or occurring thermal event, rotation of drive component 920 may be effected and electrodes 930 may be withdrawn from contact with conduit 105. In this manner, no component of the measuring device of which retractable electrode assembly 900 is a part risks suffering damage due to thermal strains resulting from expansion of one or more components.

In a further aspect, upon a determination that the thermal event has passed and/or is no longer a threat, drive component 920 may again be rotated in a direction causing one or more electrodes 930 to move back into a protracted position in which they extend through electrode windows 912 of main body 910 and/or re-establish electrical contact with conduit 105.

The embodiment of a retractable electrode assembly in FIGS. 9 and 10 is only exemplary. It should be appreciated that any suitable structure and/or method for automatically or selectively retracting one or more electrodes away from conduit 105 in response to a detected condition or command can be used. For example, in alternative embodiments, suitable retractable electrode assemblies may comprise axial slips, torsional cams, pivoting arms, mechanical bow springs, radial screw posts, inflates (swell packers), and eccentric rings, only to name some possibilities.

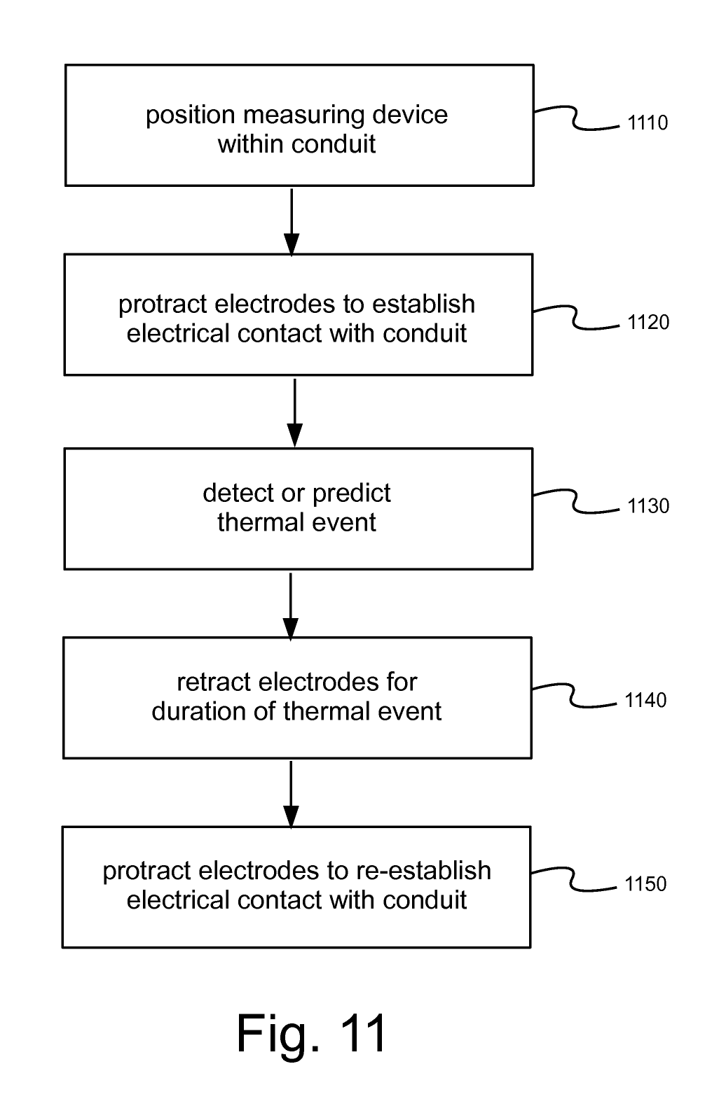

FIG. 11 depicts an exemplary embodiment of a method for utilizing a measuring device comprising one or more retractable electrode assemblies within an operating environment. At step 1110, a measuring device as described previously herein may be positioned within a production conduit. The conduit may be a well casing, a subterranean pipeline, or an aboveground pipeline. In one aspect, after the measuring device has been positioned within the conduit at a desirable location, it can be secured to the inner wall of the conduit using any of the aforementioned structure and/or methods. In one embodiment, the measuring device may be secured within the conduit using one or more anchor systems. In other embodiments, a receptacle system or one or more electrode assemblies may be used to secure the measuring device.

At step 1120, the one or more retractable electrode assemblies may be signaled and the electrodes may move into a protracted position in which they contact the inner wall of the conduit. In one aspect, the electrodes may establish sufficient contact with the inner wall of the conduit so as to provide a reliable electrical connection therebetween. In other embodiments, the protracted electrodes may not only serve to provide a reliable electrical connection with the conduit, but may also serve to secure the measuring device within the conduit as described above with respect to step 1110.

Before or after establishment of an electrical connection with the conduit, components within an electronics vessel of the measuring device may begin sensing, collecting, storing, and analyzing various information regarding the production environment, including temperature of fluids or gases flowing through or around the measuring device. Further, upon establishment of the electrical connection with the conduit, information can be transmitted to, and received from, the surface and/or other equipment within the conduit.

At step 1130, a commenced, ongoing, impending, or likely thermal event may be detected. The event may be detected by the measuring device, by some other equipment within the conduit, or by equipment/operators at the surface. Alternatively, the event may be detected based, at least in part, on information gathered and/or analysis performed across multiple devices or operators within and outside the conduit.

Upon detection of the commenced, ongoing, impending, or likely thermal event, the retractable electrode assembly may be signaled and the electrodes may move into a retracted position away from the inner wall of the conduit at step 1140. In some embodiments, the electrodes may retreat only a distance necessary such that contact with the inner wall of the conduit is lost. In other embodiments, the electrodes may retreat through corresponding electrode windows and into the retractable electrode assembly. Regardless, the electrodes are retracted sufficiently such that no substantial interface between the measuring device and the conduit exists at which to develop undesirable thermal strains resulting from any expansion of the components of the measuring device resulting from the thermal event.

It should be appreciated that in order to maintain the position of the measuring device within the conduit, some contact with the inner wall of the conduit should be maintained. For instance, where measuring device comprises a pair of retractable electrode assemblies for securing the measuring device and establishing electrical contact with the conduit (and no other securing means such as an anchor system, a receptacle system, or other type of electrode assembly is present in the measuring device), then only one of the retractable electrode assemblies need be signaled to retract. Alternatively, where a pair of retractable electrode assemblies are accompanied by an anchor system, a receptacle system, or another electrode assembly, then both retractable electrode assemblies may be signaled to retract without fear of altering the position of the measuring device within the conduit.

At step 1150, it may be determined that the thermal event (or threat thereof) has passed or is no longer a concern. This determination may be made by the measuring device, by some other equipment within the conduit, or by equipment/operators at the surface. Alternatively, the determination may be made based, at least in part, on information gathered and/or analysis performed across multiple devices or operators within and outside the conduit.

Once it is determined that the thermal event is no longer a threat, the retractable electrode assembly or assemblies can be signaled and the electrodes can move back into a protracted position where securement and/or electrical contact may be re-established with the inner wall of the conduit.

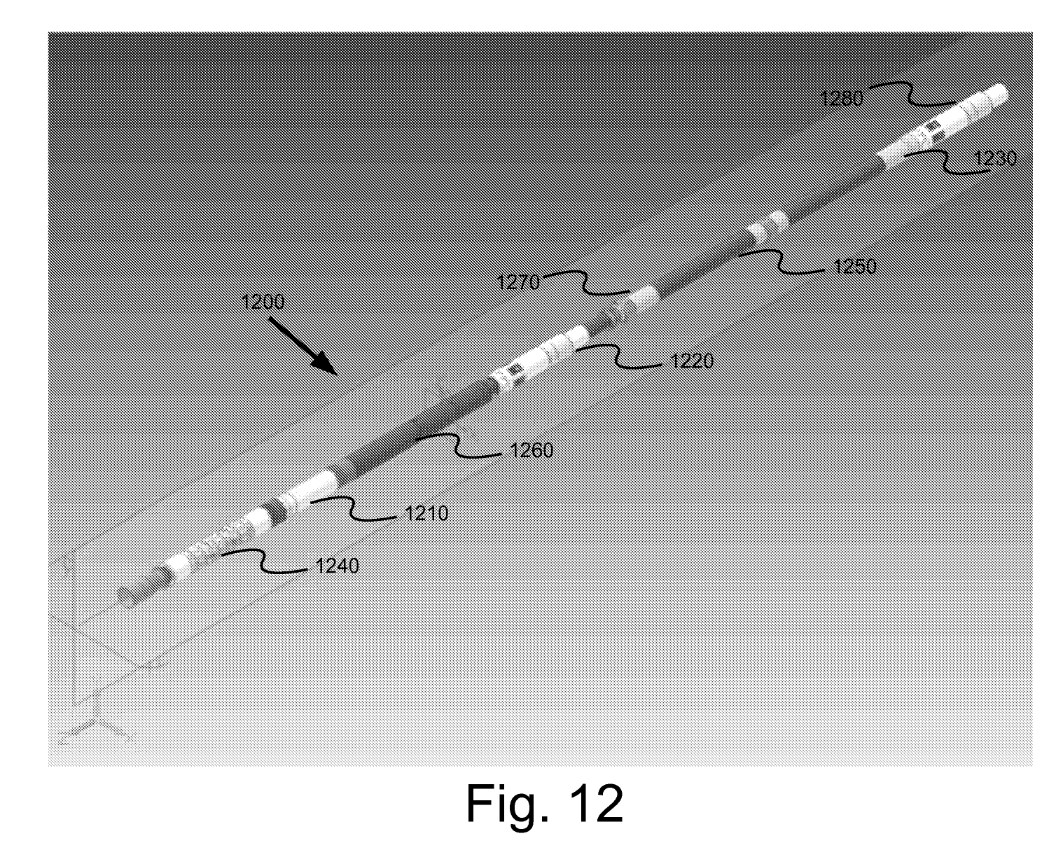

FIG. 12 depicts another exemplary embodiment of a measuring device described herein. In one aspect, the depicted measuring device may be configured for measuring the temperature and pressure of fluids or gases within a conduit and wirelessly transmitting that information to the surface or to a seafloor receiver. The measuring device may further be configured for receiving information from the surface, a seafloor receiver, or other equipment within the operating environment.

Measuring device 1200 may comprise an electronics vessel 1210, a pair of electrode assemblies 1220, 1230, and a power source 1240. In the particular embodiment depicted, the power source may be a turbine alternator that can serve to power the measurement and control electronics within electronics vessel 1210.

In another aspect, output and input signals of the electronics vessel may be coupled to electrode assemblies 1220, 1230 and a conductive spacer 1250 by a transformer chamber 1260. An expansion joint 1270 may be interposed between the electrode assemblies, thereby protecting device 1200 from thermal strains resulting from thermal events in the production environment. Measuring device 1200 may be further configured for securement within the conduit or casing by an anchor system (not shown) substantially similar to those described above by way of an adapter 1280. In a further aspect, measuring device 1200 may comprise a through-bore running the length of the device, allowing fluids or gases within the conduit to move through the device in operation.

All the embodiments of a measuring device described above can be used in a conduit for detecting, measuring, storing, analyzing, transmitting, or receiving information pertaining to a production environment. A method of use can comprise the provision of one or more of the devices described above, including but not limited to a measuring device comprising one or more electrode assemblies, flexible electrode assemblies, retractable electrode assemblies, and/or flexible couplings.

Additional features can also be incorporated into the described systems and methods to improve their functionality. For example, while the aforementioned embodiments guard against thermal strain resulting from a thermal event, there are also strains and vibrations which can develop in the measuring device due to excitation of resonances in the measuring device caused by fluids or gases flowing within the conduit. It is particularly important to understand these resonances with respect to the spacing of the electrode assemblies and anchor mounting hardware (including receptacle systems) along the elongate body of a measuring device. It is often necessary to include additional mechanical contacts or damping along the body of the measuring device in order to control or mitigate these vibrations. Only with a well-connected, stable electrode system can communications be successfully conducted over long time periods in a live production environment.

The aforementioned embodiments and accompanying description have been set forth for illustrative purposes and should not be construed as limiting the scope of this disclosure, but as merely providing examples of some presently preferred embodiments. Other embodiments, including but not limited to various modifications and alternatives to those presented herein, will be apparent to those skilled in the art from consideration of the specification and practice of this disclosure. It is intended that the specification and examples be considered as exemplary only, with the true scope and spirit of the disclosure being indicated by the following claims.

What is claimed is:

1. A measuring apparatus for use within a live oil or gas production environment, the apparatus comprising:
a first electrical contact component establishing electrical contact between the apparatus and a conduit;
a second electrical contact component establishing electrical contact between the apparatus and the conduit;
an electronics vessel in electrical communication with the conduit through the first and second electrical contact components, the electronics vessel comprising one or more sensors for sensing properties of interest within the conduit,
wherein the apparatus withstands thermal expansion without inducing a strain at the first or second electrical contact components.

2. The apparatus of claim 1, further comprising a flexible coupling interposed between the first and second electrical contact components.

3. The apparatus of claim 2, wherein the flexible coupling is an expansion joint.

4. The apparatus of claim 1, further comprising a flexible electrode assembly comprising the first electrical contact component, the flexible electrode assembly configured to translate along a central axis of the apparatus.

5. The apparatus of claim 4, wherein the flexible electrode assembly further comprises:
an actuator rod; and
a shoe deployment ring configured to slidingly engage the actuator rod, the shoe deployment ring being coupled to the first electrical contact component.

6. The apparatus of claim 1, further comprising a retractable electrode assembly comprising the first electrical contact component.

7. The apparatus of claim 6, wherein the retractable electrode assembly further comprises:
a main body;
a drive component positioned within the main body and comprising a drive rail protrusion, the drive rail protrusion extending along an arced path;
wherein the first electrical contact component comprises a slot for slidingly engaging the drive rail protrusion such that rotation of the drive component causes a translation of the first electrical contact component along the drive rail protrusion.

8. The apparatus of claim 7, wherein when the first electrical contact component is positioned at a first end of the drive rail protrusion, the first electrical contact component is positioned within main body, and
wherein when the first electrical contact component is positioned at a second end of the drive rail protrusion, at least a portion of the first electrical contact component protrudes outward from the main body.

9. The apparatus of claim 8, wherein when the first electrical contact component is positioned at the second end of the drive rail protrusion, the portion of the first electrical contact component is in contact with the conduit.

10. The apparatus of claim 9, wherein the retractable electrode assembly receives an electrical signal causing the drive component to rotate and the first electrical contact component to translate along the drive rail protrusion.

11. A method for measuring properties of interest within an oil or gas production environment, the method comprising:
positioning a measuring device within a conduit, the measuring device comprising at least one retractable electrode assembly, the at least one retractable electrode assembly comprising at least one electrode;
positioning the at least one electrode in a protracted position in contact with the conduit;
positioning the at least one electrode in a retracted position during a thermal event; and
re-positioning the at least one electrode in the protracted position after the thermal event.

12. The method of claim 11, further comprising securing the measuring device within the conduit by an anchor system.

13. The method of claim 12, wherein the anchor system comprises a second electrode for establishing an electrical connection between the measuring device and the conduit and securing the measuring device within the conduit.

14. The method of claim 12, wherein the anchor system comprises a bore receptacle for receiving and securing the measuring device.

15. The method of claim 14, further comprising securing the bore receptacle within the conduit prior to receiving and securing the measuring device.

16. The method of claim 11, wherein the measuring device comprises a second electrode assembly, the second electrode assembly comprising a second electrode, the method further comprising:
positioning the second electrode in contact with the conduit; and
while the at least one electrode is positioned in a retracted position during the thermal event, leaving the second electrode in contact with the conduit.

17. A measuring device for use within a production environment, the device comprising:
a setting component configured to secure the measuring device within a conduit at a first interface;
a first electrode configured to contact the conduit at a second interface;
an electronics vessel comprising one or more sensors for sensing properties of interest; and
a strain-reducing component for preventing strain at the first and the second interface when the measuring device undergoes a thermal expansion.

18. The method of claim 17, wherein the strain-reducing component is an expansion joint.

19. The method of claim 18, wherein the expansion joint comprises a first portion and a second portion, each having opposing, elongate teeth configured to mate and facilitate movement between the first and the second portion without losing contact between the two portions.

20. The method of claim 17, wherein the strain-reducing component is configured to translate along an axis substantially parallel or coincident with a central axis of the device.
